(19) United States
(12) Patent Application Publication
(10) Pub. No.: US 2023/0177357 A1
(43) Pub. Date: Jun. 8, 2023

(54) METHODS AND SYSTEMS FOR PREDICTING RELATED FIELD NAMES AND ATTRIBUTES NAMES GIVEN AN ENTITY NAME OR AN ATTRIBUTE NAME

(71) Applicant: BABU VINOD, Fremont, CA (US)

(72) Inventor: BABU VINOD, Fremont, CA (US)

(21) Appl. No.: 17/943,166

(22) Filed: Sep. 12, 2022

Related U.S. Application Data
(60) Provisional application No. 63/243,171, filed on Sep. 12, 2021.

(51) Int. Cl. G06N 5/022; G06N 5/048

(52) U.S. Cl. CPC G06N 5/022; G06N 5/048

(57) ABSTRACT

In one aspect, a computerized method for predicting a related field name and an attributes name given an entity name or an attribute name comprising: mining an entity name, a field name, and a datatype information as an extracted data from a specified open source; aggregating the extracted data as a domain knowledge base; implementing an approximate match on an entity name and a field name using a pre-trained word embedding; given the entity name, performing a look up to find one or more closely matching entity names and obtaining a list of potential attributes; and using the domain knowledge base to train a deep learning neural network to predict the attribute name given the entity name or an attribute name.

### CLAIM OF PRIORITY

This application claims priority to U.S. Provisional Patent application No. 63/243,171, titled METHODS AND SYSTEMS FOR PREDICTING RELATED FIELD NAMES AND ATTRIBUTES NAMES GIVEN AN ENTITY NAME OR AN ATTRIBUTE NAME, and filed on 12 Sep. 2021. This provisional application is hereby incorporated by reference in its entirety.

### SUMMARY OF INVENTION

In one aspect, a computerized method for predicting a related field name and an attributes name given an entity name or an attribute name comprising: mining an entity name, a field name, and a datatype information as an extracted data from a specified open source; aggregating the extracted data as a domain knowledge base; implementing an approximate match on an entity name and a field name using a pre-trained word embedding; given the entity name, performing a look up to find one or more closely matching entity names and obtaining a list of potential attributes; and using the domain knowledge base to train a deep learning neural network to predict the attribute name given the entity name or an attribute name.

### BACKGROUND

It is noted that a software application can comprise a set of screens, software implementing business logic, and back-end database(s). Data records exist in all these layers in different forms. They can appear as forms and fields in screens, value objects in the business logic and tables and documents in the database. In order to automate application construction automatically generating these data records are important since they form the basis for the entire application. For any given domain these data records comprise a set of entities and their attributes of fields and their data types. Improvements are accordingly desired to improve the ability to predict attributes or fields given an entity name or related fields given a field name, along with the field data type.

### BRIEF DESCRIPTION OF THE DRAWINGS

FIG. 1 illustrates an example system used for predicting related field names and attributes names given an entity name or an attribute name, according to some embodiments.

FIG. 2 illustrates an example process for predicting related field names and attributes names given an entity name or an attribute name, according to some embodiments.

FIG. 3 is a block diagram of a sample computing environment that can be utilized to implement various embodiments.

The Figures described above are a representative set and are not an exhaustive with respect to embodying the invention.

### DESCRIPTION

Disclosed are a system, method, and article of manufacture for predicting related field names and attributes names given an entity name or an attribute name. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment; ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Bidirectional Encoder Representations from Transformers (BERT) is a transformer-based machine learning technique for natural language processing (NLP) pre-training.

Deep neural network (DNN) is an artificial neural network (ANN) with multiple layers between the input and output layers. There are different types of neural networks but they always consist of the same components: neurons, synapses, weights, biases, and functions.

Domain ontology can represent concepts which belong to a realm of the world. Each domain ontology can model domain-specific definitions of terms.

Generative Pre-trained Transformer 2 (GPT-2) is an open-source artificial intelligence.

k-nearest neighbors algorithm (k-NN) is a non-parametric classification method. It can be used for classification and regression. The input can include the k closest training examples in data set. The output may depend on whether k-NN is used for classification or regression. In k-NN classification, the output is a class membership. An object is classified by a plurality vote of its neighbors, with the object being assigned to the class most common among its k nearest neighbors (e.g. k is a positive integer, typically small). If k=1, then the object is simply assigned to the class of that single nearest neighbor. In k-NN regression, the output is the property value for the object. This value is the average of the values of k nearest neighbors.

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, logistic regression, and/or sparse dictionary learning. Random forests (RF) (e.g. random decision forests) are an ensemble learning method for classification, regression, and other tasks, that operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Web Ontology Language (OWL) is a family of knowledge representation languages for authoring ontologies. Ontologies can be a formal way to describe taxonomies and classification networks, essentially defining the structure of knowledge for various domains: the nouns representing classes of objects and the verbs representing relations between the objects.

Word embedding can be a term used for the representation of words for text analysis, typically in the form of a real-valued vector that encodes the meaning of the word such that the words that are closer in the vector space are expected to be similar in meaning. Word embeddings can be obtained using a set of language modeling and feature learning techniques where words or phrases from the vocabulary are mapped to vectors of real numbers. Methods to generate this mapping include, inter alia: neural networks, dimensionality reduction on the word co-occurrence matrix, probabilistic models, explainable knowledge base method, and explicit representation in terms of the context in which words appear.

User interface (UI) is the space where interactions between humans and machines occur. A UI can include a graphical user interface (GUI) as a form of UI that allows users to interact with electronic devices through graphical icons and audio indicator such as primary notation.

Word2vec is a technique for natural language processing algorithm that uses a neural network model to learn word associations from a large corpus of text. Once trained, such a model can detect synonymous words or suggest additional words for a partial sentence. Word2vec represents each distinct word with a particular list of numbers called a vector.

Example Systems and Methods

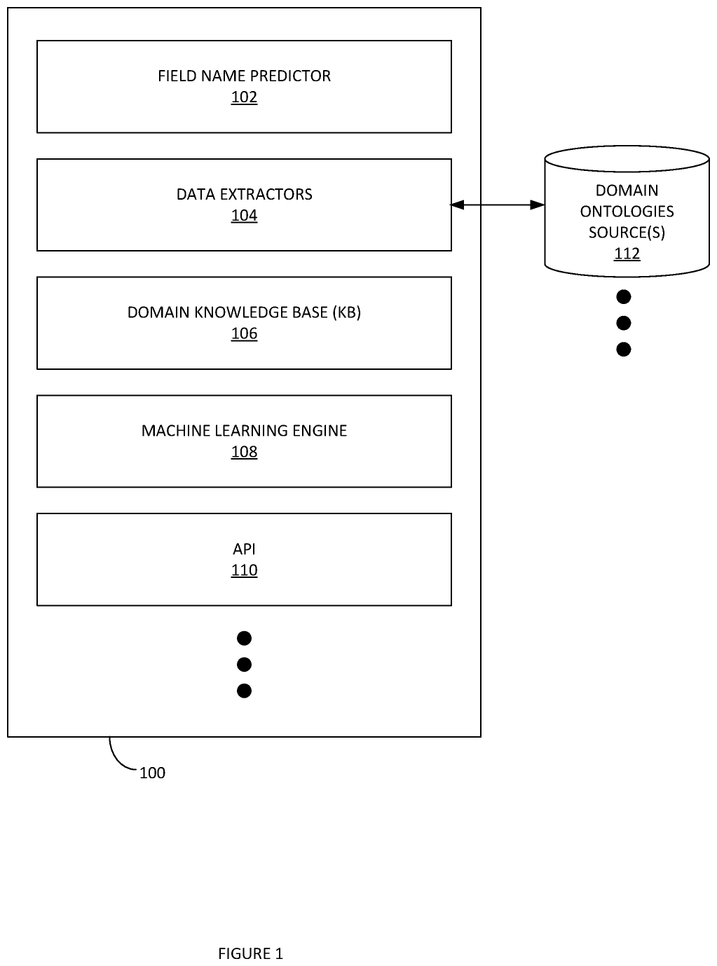

FIG. 1 illustrates an example system 100 used for predicting related field names and attributes names given an entity name or an attribute name, according to some embodiments. System 100 can include field name predictor module 202. Field name predictor module 202 can be used to predict field names given an entity name or a related field name. The invention also proposes a method to predict a field's data type given the field name and the entity name containing it.

Data extractors 104 can extract domain ontologies source(s) 112 and generate domain knowledge base (KB) 106. Data extractors 104 can mine entity, attribute, and datatype information from various sources such as API specifications, domain ontologies (e.g., OWL), natural language documents, Wikidata, DBpedia. Data extractors 104 may be rule-based or may use machine learning (ML) and natural language processing (NLP) techniques or a combination of these for data extraction. Some of the sources such as domain ontology sources 112 and API specifications also provide field data type information.

System 100 can include ML engine 108. ML engine 108 can use various ML methods to generate models that can optimize and/or automate UI programming. For example, ML engine 108 can used for used to train a deep neural network, which is used to predict field names given an entity or related field name. Datatype prediction may be done by the same neural network or another deep neural network trained using the datatype data from the KB. A combined approach may also be taken where the trained neural network and the KB are both queried and the results are combined. In certain embodiments the deep neural network employs sequence-to-sequence architecture and the transformer architecture. In another embodiment, an architecture search is used to obtain the best suitable architecture for the prediction.

In one example, ML engine 108 for automatically predicting related field names and attributes names given an entity name or an attribute name. API 110 can be used by a predicting related field names and attributes names given an entity name or an attribute name to access the services of system 100.

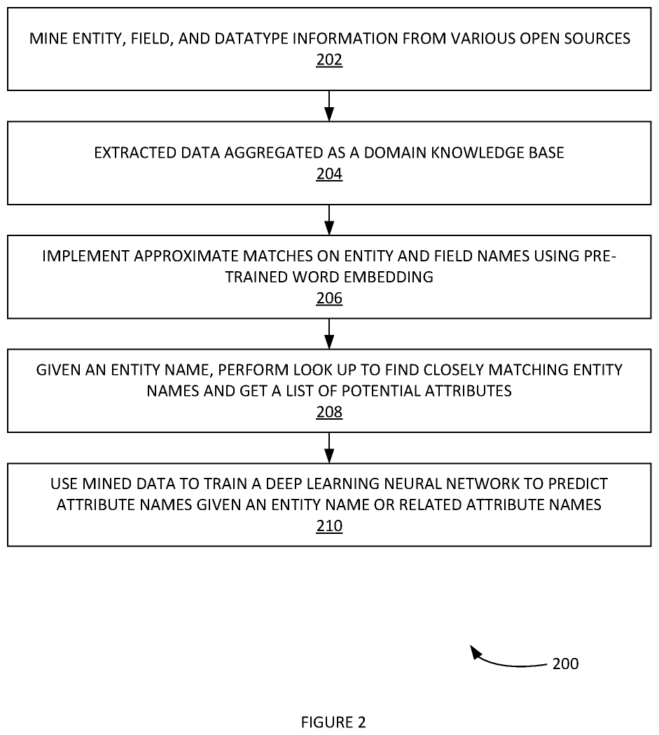

FIG. 2 illustrates an example process 200 for predicting related field names and attributes names given an entity name or an attribute name, according to some embodiments. Process 200 can be used by system 100. Process 200 can use a set of data extractors (e.g. data extractors 104, etc.) that mine entity, attribute(s), and datatype information from various sources such as, inter alia: API specifications, Domain ontologies (e.g., OWL), natural language documents, Wikidata, DBpedia, etc. These data extractors may be rule-based and/or may use machine learning (ML) and/or natural language processing (NLP) techniques or a combination of these for data extraction. Some of the sources such as domain ontologies and API specifications also provide field data type information.

The extracted data is used to populate a Domain Knowledge Base (KB). In one embodiment, word embedding based KNN indexes are generated for this KB. Pre-trained word embeddings (e.g. Word2Vec, Glove, Universal Sentence Encoding, etc.) can be extracted and BERT may be used. This can enable fast approximate look up based on entity or field names. Given an entity name (or a field name) its word embedding is computed and closest matches are looked up in the KNN index. Corresponding entity/field names can be produced as output. The usage statistics can be tracked and output data sorted according to usage priorities.

In another embodiment, the data in the KB is used to train a deep neural network, which is used to predict field names given an entity or related field name. Datatype prediction may be done by the same neural network or another deep neural network trained using the datatype data from the KB.

A combined approach may also be taken where the trained neural network and the KB are both queried and the results are combined. In certain embodiments the deep neural network employs sequence-to-sequence architecture and the transformer architecture. In another embodiment, an architecture search is used to obtain the best suitable architecture for the prediction.

In certain embodiments transfer learning from pretrained language models such as BERT and GPT-2 is used to obtain better generalization capability and reduce training data requirements. In certain embodiments the neural model consists of domain agnostic layers followed by domain specific layers, which may yield better accuracy. In certain embodiments the DKB is maintained in a graph database with versioning. Versioning enables updates in the DKB to be propagated to downstream applications in a controlled fashion.

More specifically, in step 202, process 200 can mine entity, field, and datatype information from various open sources. In step 204, the extracted data can be aggregated as a domain knowledge base. In step 206, process 200 can implement approximate matches on entity and field names using pre-trained word embedding. In step 208, given an entity name, process 200 can perform look up to find closely matching entity names and get a list of potential attributes. In step 210, process 200 can use mined data to train a deep learning neural network to predict attribute names given an entity name or related attribute names.

Example Machine Learning Implementations

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning. Random forests (RF) (e.g. random decision forests) are an ensemble learning method for classification, regression, and other tasks, that operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, that is a set of examples used to fit the parameters (e.g. weights of connections between neurons in artificial neural networks) of the model. The model (e.g. a neural net or a naive Bayes classifier) is trained on the training dataset using a supervised learning method (e.g. gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g. the number of hidden units in a neural network). Validation datasets can be used for regularization by early stopping: stop training when the error on the validation dataset increases, as this is a sign of overfitting to the training dataset. Finally, the test dataset is a dataset used to provide an unbiased evaluation of a final model fit on the training dataset. If the data in the test dataset has never been used in training (e.g. in cross-validation), the test dataset is also called a holdout dataset.

Additional Example Computer Architecture and Systems

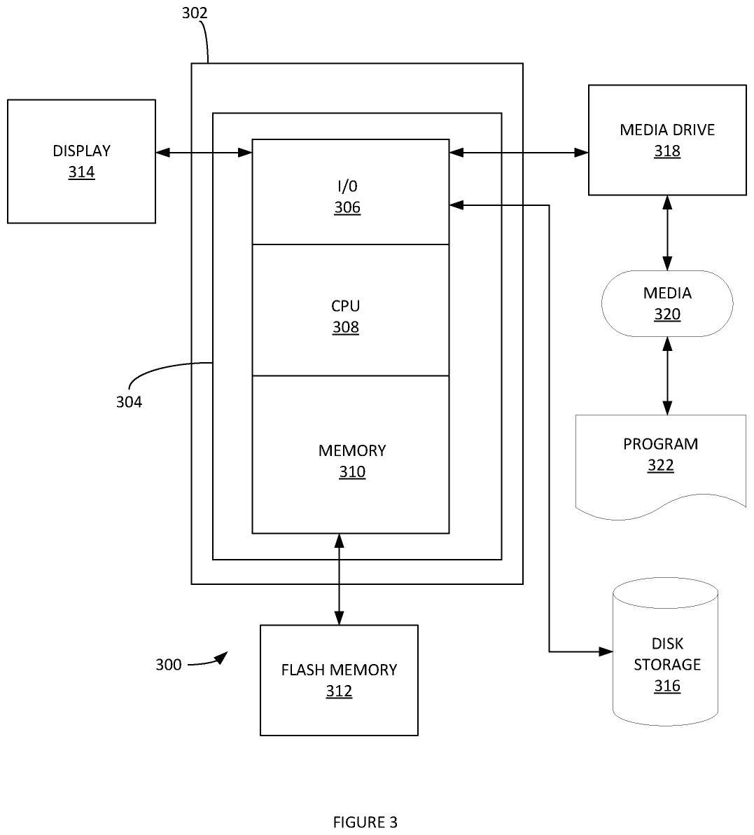

FIG. 3 depicts an exemplary computing system 300 that can be configured to perform any one of the processes provided herein. In this context, computing system 300 may include, for example, a processor, memory, storage, and I/O devices (e.g., monitor, keyboard, disk drive, Internet connection, etc.). However, computing system 300 may include circuitry or other specialized hardware for carrying out some or all aspects of the processes. In some operational settings, computing system 300 may be configured as a system that includes one or more units, each of which is configured to carry out some aspects of the processes either in software, hardware, or some combination thereof.

FIG. 3 depicts computing system 300 with a number of components that may be used to perform any of the processes described herein. The main system 302 includes a motherboard 304 having an I/O section 306, one or more central processing units (CPU) 308, and a memory section 310, which may have a flash memory card 312 related to it. The I/O section 306 can be connected to a display 314, a keyboard and/or other user input (not shown), a disk storage unit 316, and a media drive unit 318. The media drive unit 318 can read/write a computer-readable medium 320, which can contain programs 322 and/or data. Computing system 300 can include a web browser. Moreover, it is noted that computing system 300 can be configured to include additional systems in order to fulfill various functionalities. Computing system 300 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by United States Patent:

1. A computerized method for predicting a related field name and an attributes name given an entity name or an attribute name comprising:
mining an entity name, a field name, and a datatype information as an extracted data from a specified open source;
aggregating the extracted data as a domain knowledge base;
implementing an approximate match on an entity name and a field name using a pre-trained word embedding;
given the entity name, performing a look up to find one or more closely matching entity names and obtaining a list of potential attributes; and
using the domain knowledge base to train a deep learning neural network to predict the attribute name given the entity name or an attribute name.

2. The computerized method of claim 1, wherein a word embedding based K-NN index is generated from the domain knowledge base.

3. The computerized method of claim 2, wherein for the entity name a word embedding is computed.

4. The computerized method of claim 3, wherein a set of closest matches are looked up in the word embedding based K-NN index and a corresponding entity name is produced as an output.

5. The computerized method of claim 2, wherein for the field name the word embedding is computed.

6. The computerized method of claim 3, wherein the set of closest matches are looked up in the word embedding based K-NN index and a corresponding field name is produced as the output.

7. The computerized method of claim 1, wherein a pre-trained word embedding is extracted from the domain knowledge base and Bidirectional Encoder Representations from Transformers (BERT) is utilized for an approximate look up based on the entity name or field name.

8. A computerized system for predicting a related field name and an attributes name given an entity name or an attribute name comprising:
a processor;
a memory containing instructions when executed on the processor, causes the processor to perform operations that:
mine an entity name, a field name, and a datatype information as an extracted data from a specified open source;
aggregate the extracted data as a domain knowledge base;
implement an approximate match on an entity name and a field name using a pre-trained word embedding;
given the entity name, perform a look up to find one or more closely matching entity names and obtain a list of potential attributes; and
use the domain knowledge base to train a deep learning neural network to predict the attribute name given the entity name or an attribute name.

9. The computerized system of claim 8, wherein a word embedding based K-NN index is generated from the domain knowledge base.

10. The computerized system of claim 9, wherein for the entity name a word embedding is computed.

11. The computerized system of claim 10, wherein a set of closest matches are looked up in the word embedding based K-NN index and a corresponding entity name is produced as an output.

12. The computerized system of claim 9, wherein for the field name the word embedding is computed.

13. The computerized system of claim 10, wherein the set of closest matches are looked up in the word embedding based K-NN index and a corresponding field name is produced as the output.

14. The computerized system of claim 8, wherein a pre-trained word embedding is extracted from the domain knowledge base and Bidirectional Encoder Representations from Transformers (BERT) is utilized for an approximate look up based on the entity name or field name.
